(19) United States
(12) Patent Application Publication
(10) Pub. No.: US 2001/0029466 A1
(43) Pub. Date: Oct. 11, 2001

(54) Rewarding method corresponding to object selection on web page and server for use with rewarding method

(75) Inventor: Masaki Ichihara, Tokyo (JP)

Correspondence Address: David A. Blumenthal, FOLEY & LARDNER, Washigton Harbour, 3000 K Street, N.W., Suite 500, Washington, DC, 20007-5109, US

(73) Assignee: NEC COPORATION

(21) Appl. No.: 09/822,274

(22) Filed: Apr. 2, 2001

(30) Foreign Application Priority Data
Apr. 6, 2000 (JP) 2000-105346

(51) Int. Cl. G06F 17/60; G06F 15/173

(52) U.S. Cl. 705/14; 709/224

(57) ABSTRACT

A rewarding method corresponding to an object selection on a web page, comprising the steps of: (a) designating a predetermined object to each of a plurality of web pages having respective URLs; (b) causing a server to detect that a user of a user terminal unit has selected the object on one of the plurality of web pages having respective URLs; (c) recording an event log correlating an identifier of the user, an identifier of the selected object, and an event that the object has been selected, when the server detects that the user of the user terminal unit has selected the object; (d) determining whether or not the number of objects recorded in the event log exceeds a first predetermined value; and (e) performing a rewarding process to reward the user when the determined result at the step (d) is Yes.

### BACKGROUND OF THE INVENTION

1. Field of the Invention

The present invention relates to a rewarding method corresponding to an object selection on a web page using a computer and a server for use with the rewarding method.

2. Description of the Prior Art

As the Internet has become common, an advertising business has grown. In the advertising business, the owner of a home web page earns money from an advertiser who places an advertisement on the web page. Some portal sites are managed with advertisement incomes.

However, web sites just place advertisements with banners, marks, graphics, and so forth created by advertisers or their agents. These web sites inactively expect that guests will be interested in those advertisements and visit the sites of the advertisers.

In such an advertising method on the Internet, the advertisement effects are very weak. Thus, the advertisers cannot expect high results from the advertisements. In such a method, the advertisers should create attractive banner advertisements placed in the advertisement sites.

In additions, from a view point of the guests, even if they visit such sites, since the advertisements are not attractive and the guests do not have advantageous to visit the sites, the advertisers cannot satisfy their advertisement results because it is difficult to increase the number of accesses of the advertisement sites.

### SUMMARY OF THE INVENTION

In order to overcome the aforementioned disadvantages, the present invention has been made, and therefore, has an object to provide a rewarding method corresponding to an object selection on a web page and a server for use with the rewarding method that allow advertisement effects on web pages to be improved.

According to a first aspect of the present invention, there is provided a rewarding method corresponding to an object selection on a web page, comprising the steps of: (a) designating a predetermined object to each of a plurality of web pages having respective URLs; (b) causing a server to detect that a user of a user terminal unit has selected the object on one of the plurality of web pages having respective URLs; (c) recording an event log correlating an identifier of the user, an identifier of the selected object, and an event that the object has been selected, when the server detects that the user of the user terminal unit has selected the object; (d) determining whether or not the number of objects recorded in the event log exceeds a first predetermined value; and (e) performing a rewarding process to reward the user when the determined result at the step (d) is Yes.

In the rewarding method, when the determined result at the step (d) is Yes, before performing the step (e), a quiz web page may be displayed on the user terminal unit, and when the number of correct answers that the user have input to the user terminal unit in response to the quizzes on said quiz web page is greater than a second predetermined value, the step (e) may be performed.

In the rewarding method, a link object of a web page provided by the server may be hyperlinked to any web page, URL of which contains a server name contained in the URL of one of the plurality of web pages which have the predetermined objects designated.

In the rewarding method, the link object may be a banner.

In the rewarding method, the server names contained in the plurality of URLs may be different from each other.

In the rewarding method, a web page that contains a server name contained in one of the plurality of URLs may be hyperlinked to a web page that contains a server name contained in another URL.

The rewarding method may further comprise the steps of: (f) transmitting the identifier of the user from the server to the user terminal unit; and (g) causing the user terminal unit to store the identifier of the user, wherein the step (b) is preceded by the steps (f) and (g), and wherein when the user of the user terminal unit has selected an object of a web page designated by one of the plurality of URLs, the user terminal unit may transmit the identifier of the user stored therein to the server.

The rewarding method may further comprise the steps of: (h) transmitting the identifier of the user from the server to the user terminal unit; and (i) causing the user terminal unit to display the identifier of the user, wherein the step (b) is preceded by the steps (h) and (i), and wherein when the user of the user terminal unit has selected an object of a web page designated by one of the plurality of URLs, the user terminal unit may transmit the identifier of the user that has been input to the terminal unit by the user to the server.

In the rewarding method, the user terminal unit may be a WWW browser.

In the rewarding method, the rewarding process may be a computer-implemented process for shipping a reward.

In the rewarding method, the rewarding process may be a computer-implemented process for discounting an Internet connection fee.

In the rewarding method, host names in the URLs may be WWW server names of advertisers.

In the rewarding method, the server may be a WWW server.

In the rewarding method, the server may be a WWW server of a portal site.

In the rewarding method, the server may be a WWW server of a provider.

In the rewarding method, the object may be one of a character string, a picture, or a symbol.

In the rewarding method, the object may be an advertisement.

The rewarding method may further comprise the step of: (j) totalizing the event log.

In the rewarding method, the event log may be recorded to the server.

In the rewarding method, the event log may be recorded to the user terminal unit.

The rewarding method may further comprise the step of: (k) encrypting the event log recorded to the user terminal unit.

The rewarding method may further comprise the step of: (l) transmitting user information from the user terminal unit to the server, wherein the step (b) is preceded by the step (l).

In the rewarding method, the step (e) may include the step of: transmitting the user information from the user terminal unit to the server.

In the rewarding method, the plurality of URLs may be changed to one predetermined URL.

According to a second aspect of the present invention, there is provided a server, comprising: recording means for recording an event log correlating the identifier of a user of a user terminal unit, an identifier of a selected object, and an event that the object has been selected when the user of the user terminal unit has selected one of predetermined objects on web pages designated with a plurality of predetermined URLs; first determining means for determining whether or not the number of objects recorded in the event log exceeds a predetermined value; and rewarding means for performing a rewarding process to reward the user when the determined result of said first determining means is Yes.

The server may further comprise: means for transmitting a quiz web page to the user terminal unit, when the determined result of said first determining means is Yes; and second determining means for determining whether or not the number of correct answers among answers that have been transmitted from the user terminal unit as answers to the quizzes exceeds a second predetermined value, wherein when the determined result of said first determining means is Yes and the determined result of said second determined means is Yes, said rewarding means rewards the user.

In the server, a link object of a web page provided by the server may be hyperlinked to any web page, URL of which contains a server name contained in the URL among the plurality of predetermined URLs.

In the server, the link object may be a banner.

The server may further comprise: means for transmitting the identifier of the user to the user terminal unit before said recording means operates.

In the server, said rewarding process may be a computer-implemented process for shipping a reward.

In the server, said rewarding process may be a computer-implemented process for discounting an Internet connection fee.

The server may be a WWW server. The server may be a WWW server of a portal site. The server may be a VW server of a provider.

In the server, the object may be one of a character string, a picture, or a symbol.

In the server, the object may be an advertisement.

The server may further comprise: means for totalizing the event log.

The server may further comprise: a record medium for recording the eventlog.

The server may further comprise: means for transmitting the event log to the user terminal unit.

The server may further comprise: means for encrypting the event log that is transmitted to the user terminal unit.

The server may further comprise: means for transmitting a user information input web page for inputting user information about the user to the user terminal unit; means for receiving the user information that is input to the user information input web page from the user terminal unit; and means for correlatively recording the received user information and the identifier of the user.

These and other objects, features and advantages of the present invention will become more apparent in light of the following detailed description of the best mode embodiment thereof, as illustrated in the accompanying drawings.

### BRIEF DESCRIPTION OF DRAWINGS

FIG. 1 is a schematic diagram showing the Internet and devices connected thereto of which a rewarding method is accomplished corresponding to a keyword searched on a web page of an advertiser according to an embodiment of the present invention;

FIG. 2 is a schematic diagram showing a display screen of a portal web page as a home web page of a portal WWW server shown in FIG. 1 according to a first embodiment of the present invention;

FIG. 3 is a schematic diagram showing an example of the structure of web pages of a WWW server of an advertiser A shown in FIG. 1 according to the first embodiment of the present invention;

FIG. 4 is a schematic diagram showing an example of the structure of web pages of a WWW server of an advertiser B shown in FIG. 1 according to the first embodiment of the present invention;

FIG. 5 is a schematic diagram showing an example of the structure of web pages of a WWW server of an advertiser C shown in FIG. 1 according to the first embodiment of the present invention;

FIG. 6 is a schematic diagram showing an example of the structure of web pages of a WWW server of an advertiser D shown in FIG. 1 according to the first embodiment of the present invention;

FIG. 7 is a sequence chart for explaining the operation for registering user information according to the first embodiment of the present invention;

FIG. 8 is a schematic diagram showing a user registration web page according to the first embodiment of the present invention;

FIG. 9 is a schematic diagram showing a registration notification web page according to the first embodiment of the present invention;

FIG. 10A is a schematic diagram showing the contents of a cookie transmitted along with the registration notification web page according to an embodiment of the present invention;

FIG. 10B is a schematic diagram showing the contents of a cookie registered by a WWW browser according to an embodiment of the present invention;

FIG. 11 is a sequence diagram for explaining the operation in the case that the user searches the home web page of the advertiser A for a keyword according to the first embodiment of the present invention;

FIG. 12 is a schematic diagram showing a display screen of a web page transmitted at step 1114 shown in FIG. 11 according to the first embodiment of the present invention;

FIG. 13 is a schematic diagram for explaining the operation in the case that the user searches the home web page of the advertiser C for a keyword according to the first embodiment of the present invention;

FIG. 14 is a schematic diagram showing a display screen of a web page transmitted at step 1314 shown in FIG. 13 according to the first embodiment;

FIG. 15 is a schematic diagram showing a display screen of a web page transmitted at step 1319 shown in FIG. 13 according to the first embodiment of the present invention;

FIG. 16 is a schematic diagram for explaining the operation in the case that the number of correct answers of a quiz that is issued reaches a predetermined value according to the first embodiment of the present invention;

FIG. 17 is a schematic diagram showing a display screen of a web page transmitted at step 1608 shown in FIG. 16 according to the first embodiment of the present invention;

FIG. 18 is a schematic diagram showing a web page transmitted at step 1618 shown in FIG. 16 according to the first embodiment of the present invention;

FIG. 19 is a schematic diagram for explaining the operation in the case that the number of correct answers of a quiz that is issued does not reach a predetermined value according to the first embodiment of the present invention;

FIG. 20 is a schematic diagram showing a display screen of a web page transmitted at step 1901 shown in FIG. 19 according to the first embodiment of the present invention;

FIG. 21 is a schematic diagram showing the record structure and initial values of a database 102a shown in FIG. 1 according to the first embodiment of the present invention;

FIG. 22 is a schematic diagram showing the record structure and first intermediate values of the database 102a shown in FIG. 1 according to the first embodiment of the present invention;

FIG. 23 is a schematic diagram showing the record structure and second intermediate values of the database 102a shown in FIG. 1 according to the first embodiment of the present invention;

FIG. 24 is a schematic diagram showing the record structure and third intermediate values of the database shown in FIG. 1 according to the first embodiment of the present invention;

FIG. 25 is a schematic diagram showing the record structure of the database 102a shown in FIG. 1 according to a first modification of the first embodiment of the present invention;

FIG. 26 is a schematic diagram showing the record structure of the database 102a shown in FIG. 1 according to a second modification of the first embodiment of the present invention;

FIG. 27 is a schematic diagram showing the record structure of a database 102b shown in FIG. 1 according to the first embodiment of the present invention;

FIG. 28 is a schematic diagram showing a display screen of a portal web page as a home web page of the portal WWW server shown in FIG. 1 according to a second embodiment of the present invention;

FIG. 29 is a schematic diagram for explaining the operation in the case that a request for a portal page is transmitted and a portal page is transmitted according to the second embodiment of the present invention;

FIG. 30 is a schematic diagram showing a display screen of a web page transmitted at step 1608 shown in FIG. 16 according to the second embodiment of the present invention;

FIG. 31 is a schematic diagram showing a display screen of a web page transmitted along with a web page 901 at step S711 shown in FIG. 7 according to a third embodiment of the present invention;

FIG. 32 is a sequence diagram showing the operation after a keyword A is clicked until a keyword A clicking process is started according to the third embodiment of the present invention;

FIG. 33 is a schematic diagram showing a display screen of a web page transmitted at step 3202 shown in FIG. 32 according to the third embodiment of the present invention;

FIG. 34 is a schematic diagram showing a display screen of a web page transmitted at step 1114 shown in FIG. 11 according to a seventh embodiment of the present invention; and

FIG. 35 is a schematic diagram showing a display screen of a web page transmitted at step 1114 shown in FIG. 11 or a web page transmitted at step 1314 shown in FIG. 13.

### DESCRIPTION OF PREFERRED EMBODIMENTS

Next, with reference to the accompanying drawings, embodiments of the present invention will be described.

### First Embodiment

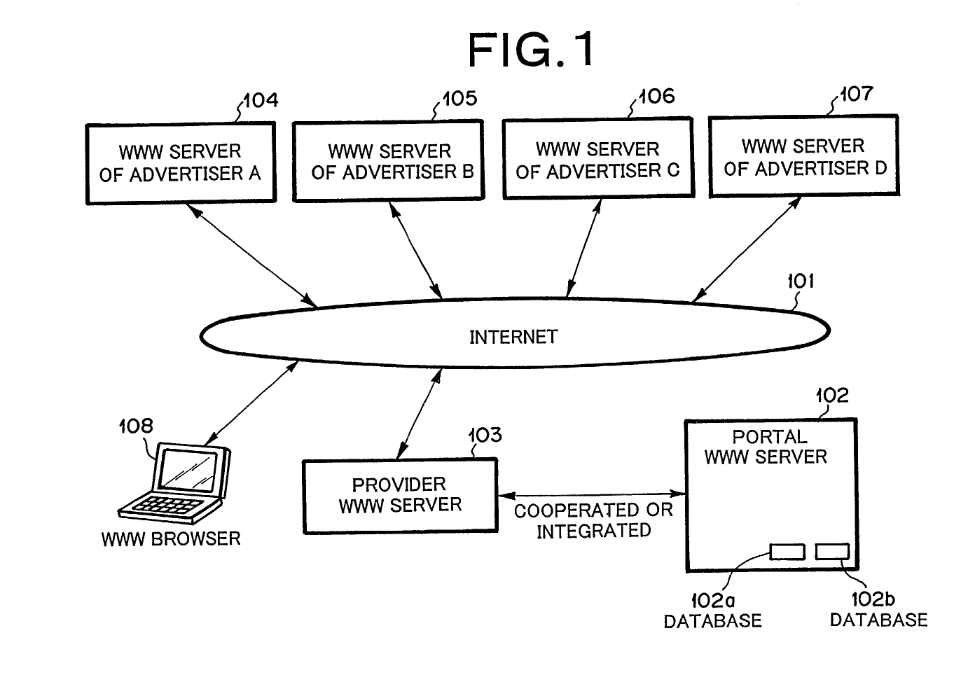

FIG. 1 is a conceptual diagram showing the Internet and devices connected thereto according to the first embodiment of the present invention.

With reference to FIG. 1, a portal WWW server 102, a provider WVW server 103, a WWW server 104 of an advertiser A, a WWW server 105 of an advertiser B, a WWW server 106 of an advertiser C, a WWW server 107 of an advertiser D, and a WWW browser 108 are connected to the Internet 101.

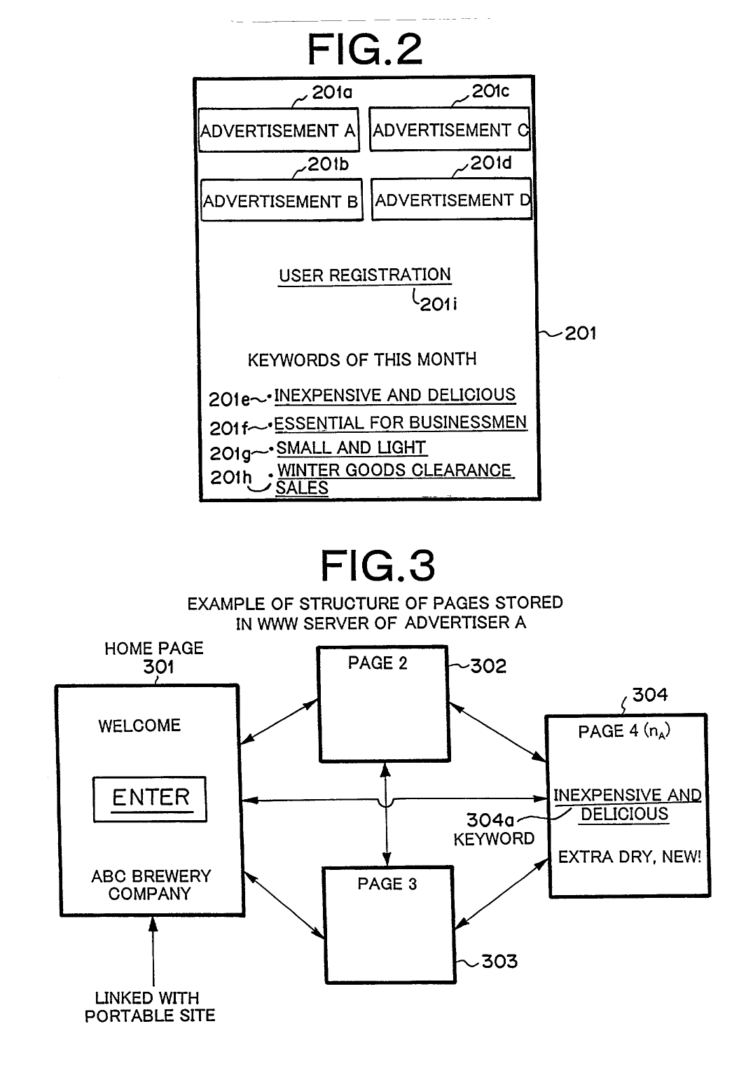

Referring to FIG. 2, a portal web page 201 that is a home web page of the portal WWW server 102 contains an advertisement banner 201a, an advertisement banner 201b, an advertisement banner 201c, an advertisement banner 201d, a keyword character string 201e, a keyword character string 201f, a keyword character string 201g, a keyword character string 201h, and a character string “user registration” 201i. Symbols, and so forth may be used instead of the advertisement banner scharacter stings although advertisement effects become weak. According to the present invention, the banners, such character strings, symbols, and so forth are referred to as “link objects”.

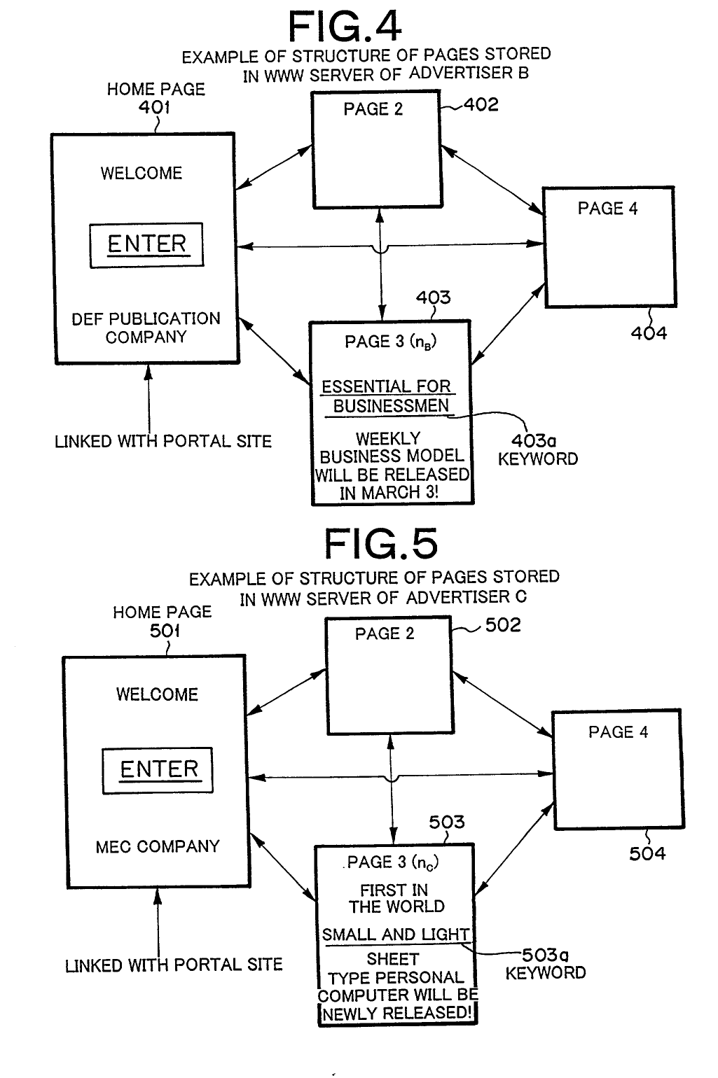

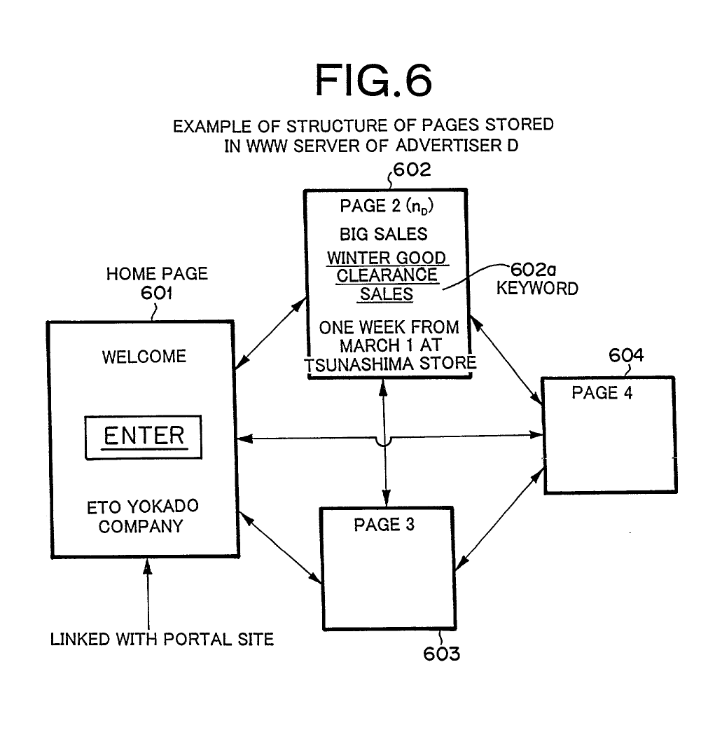

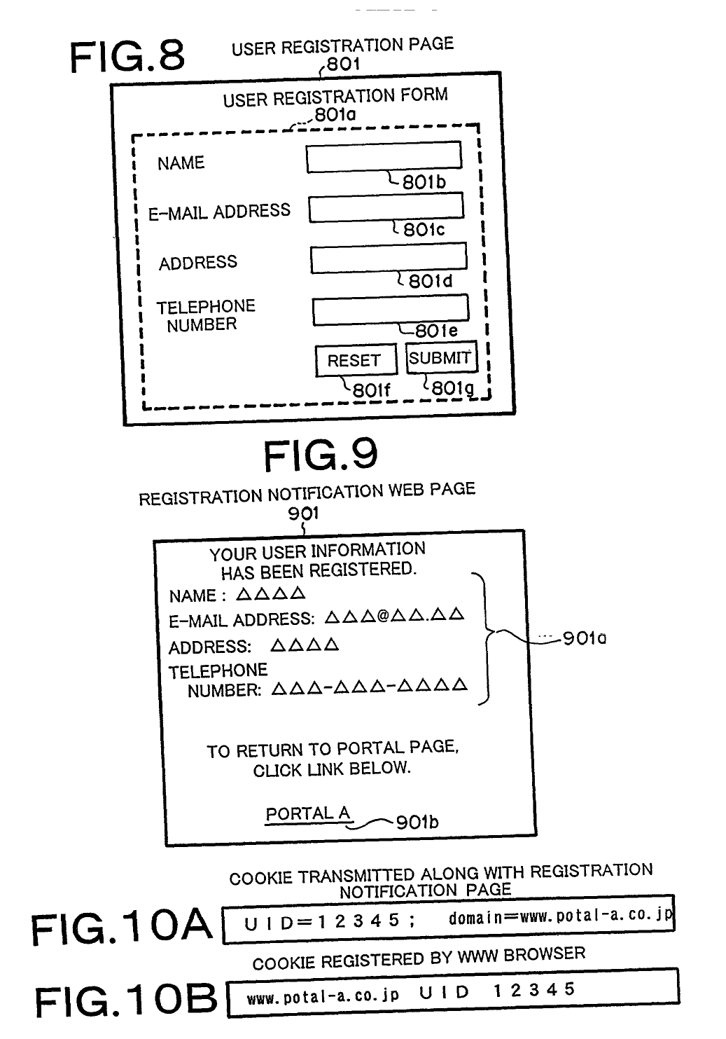

The advertisement banner 201a is hyperlinked to a home web page 301 (see FIG. 3) of the WWW server 104 of the advertiser A. The advertisement banner 201b is hyperlinked to a home web page 401 (see FIG. 4) of the WWW server 105 of the advertiser B. The advertisement banner 201c is hyperlinked to a home web page 501 (see FIG. 5) of the WWW server 106 of the advertiser C. The advertisement banner 201d is hyperlinked to a home web page 601 (see FIG. 6) of the WWW server 104 of the advertiser D. The character string 201i is hyperlinked to a user registration web page 801 (see FIG. 8) that is one of web pages stored in the portal WWW server 102.

One or more web pages (including a home web page) stored in the WWW server of the advertiser A also have the keyword character string 201e. One or more web pages (including a home web page) stored in the WWW server of the advertiser B also have the keyword character string 201f. One or more web pages (including a home web page) stored in the WWW server of the advertiser C also have the keyword character string 201g. One or more web pages (including a home web page) stored in the WWW server of the advertiser D also have keyword character string 201h.

With reference to FIG. 3, the WWW server 104 of the advertiser A stores for example four web pages 301 to 304 as HTML documents. These four web pages 301 to 304 are hyperlinked to one another. The home web page 301 is hyperlinked to the advertisement banner 201a of the portal web page 201. The fourth web page 304 has the same keyword 304a as the keyword “inexpensive and delicious” 201e (hereinafter referred to as “keyword A”). Thus, the user can reach the keyword A 304a from the portal web page 201 through hyperlinks.

Referring to FIG. 4, the WWW server 105 of the advertiser B stores for example four web pages 401 to 404 as HTML documents. These four web pages 401 to 404 are hyperlinked to one another. The home web page 401 is hyperlinked to the advertisement banner 201b of the portal web page 201. The third web page 403 has the same keyword 403a as the keyword “essential for business men” 201f (hereinafter referred to as “keyword B”). Thus, the user can reach the keyword B 403a from the portal web page 201 through hyperlinks.

Referring to FIG. 5, the W server 106 of the advertiser C stores for example four web pages 501 to 504 as HTML documents. These four web pages 501 to 504 are hyperlinked to one another. The home web page 501 is hyperlinked to the advertisement banner 201c of the portal web page 201. The third web page 503 has the same key word as a keyword “small and light” 201g (hereinafter referred to as “keyword C”). Thus, the user can reach the keyword C 503a from the portal web page 201 through hyperlinks.

Referring to FIG. 6, the WWW server 107 of the advertiser D stores for example four web pages 601 to 604 as HTML documents. These four web pages 601 to 604 are hyperlinked to one another. The home web page 601 is hyperlinked to the advertisement banner 201d of the portal web page 201. The second web page 602 has the same keyword as a keyword “winter goods clearance sales” 201h (hereinafter referred to as keyword D). Thus, the user can reach the keyword D 602a from the portal web page 201 through hyperlinks.

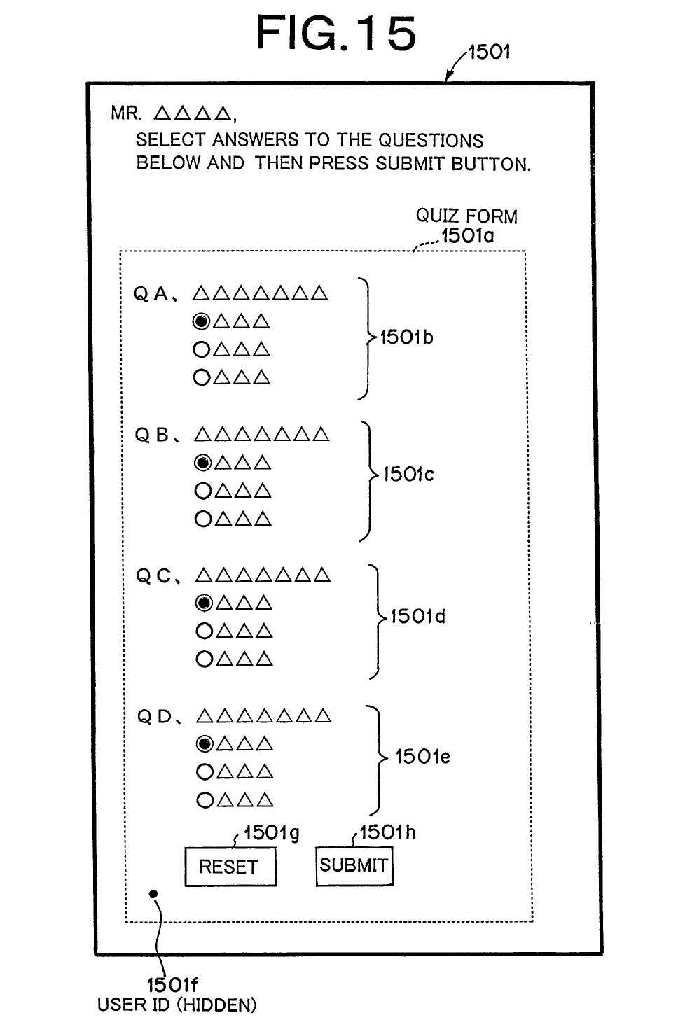

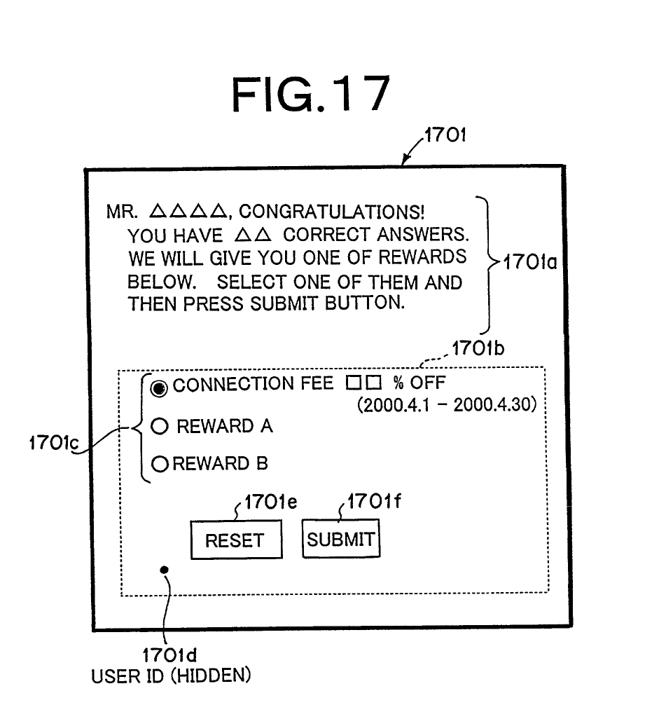

When the user of the WWW browser 108 performs the following operation, he or she can obtain his or her desired reward. The user registers his or her user information with the portal WWW server 102 through the user registration web page 801. Next, the user clicks the keywords 304a, 403a, 503a, and 602a in a any order so that the number of keywords that the user has clicked becomes a predetermined value (all or a part of the keywords). Thereafter, when a quiz web page 1501 (see FIG. 15) is displayed on the WWW browser 108, the user answers the quiz on the quiz web page 1501. When the number of correct answers reaches a predetermined value (the number of all or a part of the answers), a reward selection web page 1701 (see FIG. 17) is displayed. On the reward selection web page 1701, the user selects his or her desired reward.

Next, the operations of the devices connected to the Internet 101 will be described. These devices accomplish the operations on the user side.

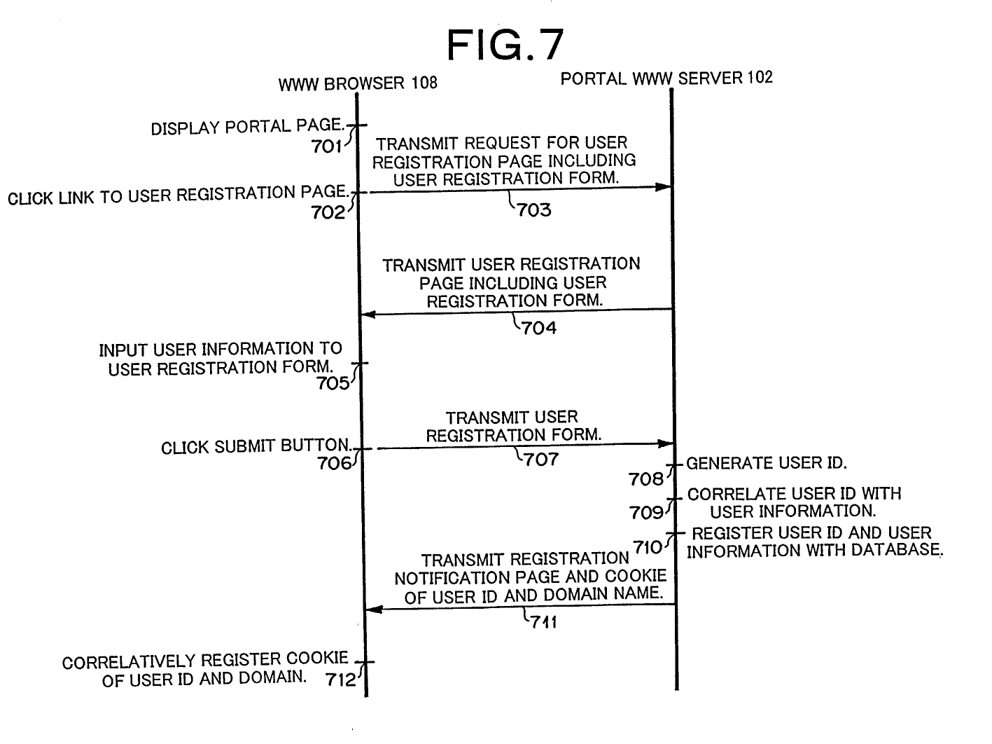

Referring to FIG. 7, when the user inputs the URL of a portal web page or clicks a proper hyperlink, the portal web page 201 is displayed on the WWW browser 108 (at step 701). When the user clicks the character string “user registration” 201i that is hyperlinked to the user registration web page 801 (at step 702), the WWW browser 108 transmits a request for the user registration web page 801 to the portal WWW server 102 (at step 703). When the portal WWW server 102 receives the request for the user registration web page 801, the portal WWW server 102 transmits the user registration web page 801 to the WWW browser 108 (at step 704).

The user registration web page 801 has a user registration form 801a. The user registration form 801a contains a text box 801b, a text box 801c, a text box 801d, a text box 801e, a reset button 801f, and a submit button 801g. The text box 801b is used to input a name. The text box 801c is used to input an e-mail address. The text box 801d is used to input an address. The text box 801e is used to input a telephone number. The reset button 801f is used to erase characters that are input to the text boxes. The submit button 801g is used to transmit the form 801a and the user information as form information added to the form 801a to the portal WWW server 102. In the user registration form 801a, information for designating a user information processing program (CGI, Java Servlet, etc) (not shown) for processing user information that is input thereto is included.

Thereafter, the user inputs user information such as e-mail address, address, and telephone number to the user registration form 801a (at step 705). When the user clicks the submit button 801g (at step 706), the WWW browser 108 transmits the user registration form 801a and the user information added thereto to the portal WWW server 102. When the portal WWW server 102 receives the user registration form 801a, a user information processing program starts a process using the user information contained in the user registration form 801a. The user information processing program generates a user ID (for example, “12345”) (at step 708), correlates the user ID with the user information (at step 709), registers the user ID and the user information with the database 102a (see FIG. 1) (at step 710), and transmits a registration notification web page 901 and a cookie of the user ID and the domain name to the WWW browser 108 (at step 711).

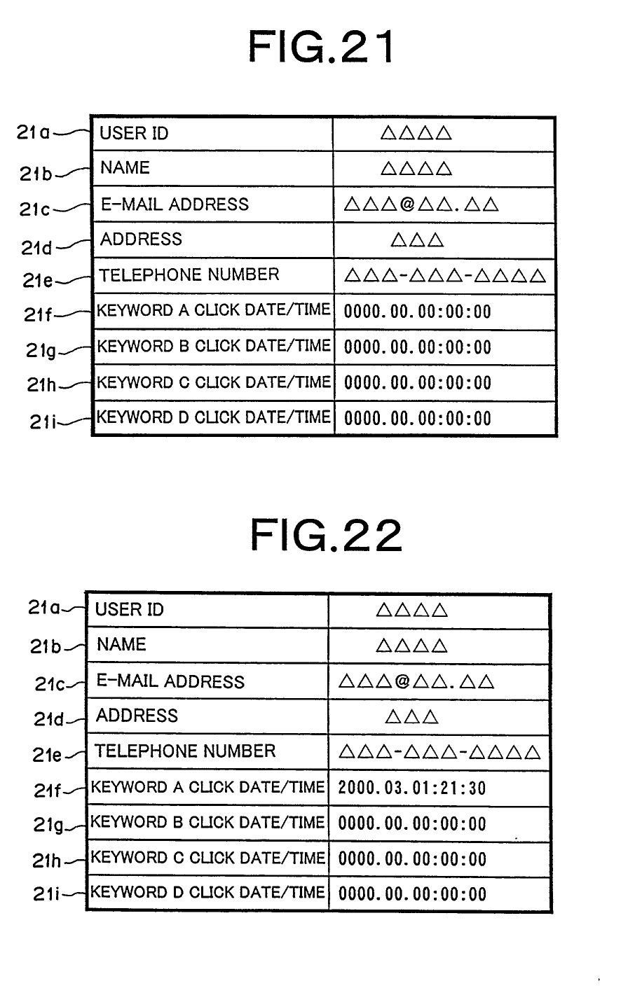

As shown in FIG. 21, one record of the database 102a contains a user ID field 21a, a name field 21b, an e-mail address field 21c, an address field 21d, a telephone number field 21e, a keyword A click date/time field 21f, a keyword B click date/time field 21g, a keyword C click date/time field 21h, and a keyword D click date/time field 21i. The user ID field 21a stores a user ID generated at step 708. The name field 21b, the e-mail address field 21c, the address field 21d, and the telephone number field 21e store user information contained in the user registration form 801a. Since the user has not clicked any keywords, the keyword A click date/time field 21f, the keyword B click date/time field 21g, the keyword C click date/time field 21h, and the keyword D click date/time field 21i store invalid time and date data (for example, 0000-00-00 : 00:00 as yyyy-mm-dd:hh:mm).

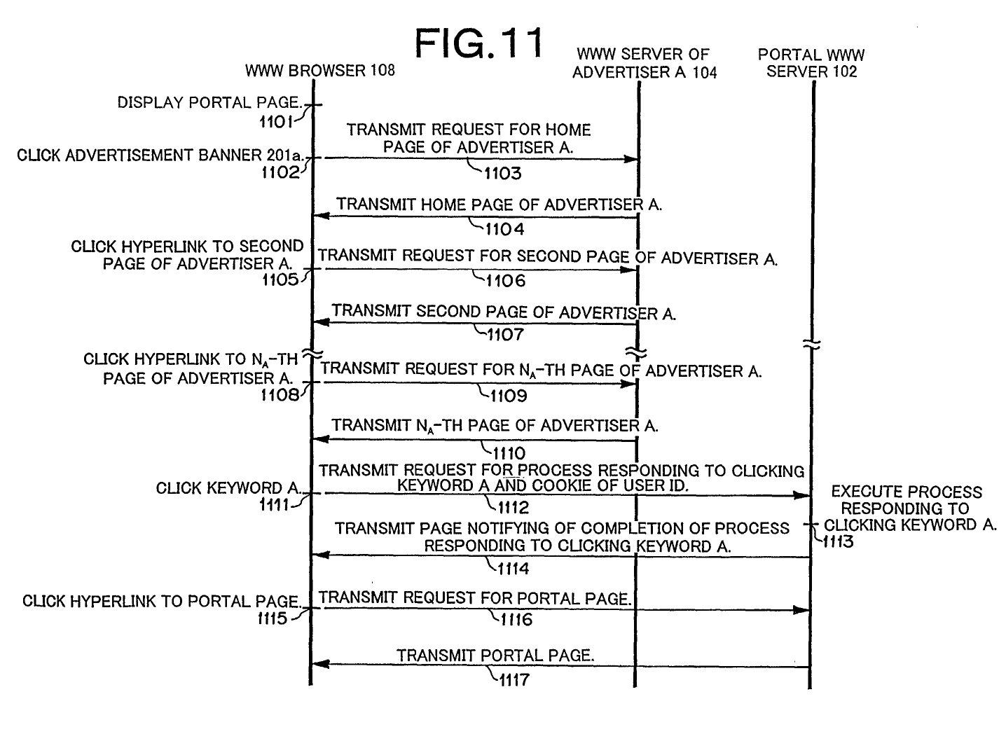

The contents of the user ID of the cookie transmitted at step 711 is the user ID (for example, “12345”) generated at step 708. The domain of the cookie is the domain name (for example, “www.potal-a.co.jp”) of the portal WWW server 102. FIG. 10A shows such an example.

Referring to FIG. 9, the registration notification web page 901 contains a character string 901a and a character string 901b. The character string 901a represents the user information. The character string 901b is associated with a hyperlink to the portal web page 201.

When the WWW browser 108 receives the registration notification web page 901 and the cookie associated therewith, the WWW browser 108 registers the contents of the received cookie to a record medium (not shown) such as a hard drive of the WWW browser in the format shown in FIG. 10B (at step 712).

Next, an example of the operation in the case that the user clicks a keyword described in a web page stored in a WWW server of an advertiser will be described.

First of all, the operation in the case that the user searches web pages provided by a WWW server of an advertiser for a non-final keyword will be described.

Referring to FIG. 11, while the WWW browser 108 is displaying the portal web page 201 (at step 1101), the user clicks the advertisement banner 201a (at step 1102). Then, the WWW browser 108 transmits a request for the home web page 301 of the advertiser A to the WWW server 104 (at step 1103). When the WWW server 104 of the advertiser A receives the request for the home web page 301, the WWW server 104 transmits the home web page 301 to the WWW browser 108 (at step 1104).

Thereafter, while the WWW browser 108 is displaying the home web page 301, the user clicks a hyperlink (not shown) to the second web page 302 of the advertiser A (at step 1105). Then, the WWW browser 108 transmits the request for the second web page 302 to the WWW server 104 of the advertiser A (at step 1106). When the WWW server 104 of the advertiser A receives the request for the web page 302, the WWW server 104 transmits the web page 302 to the WWW browser 108 (at step 1107).

Thereafter, while the WWW browser 108 is displaying any web page of the advertiser A, the user clicks a hyperlink (not shown) to the n_{A}th web page 304 of the advertiser A (at step 1108). Then, the WWW browser 108 transmits the request for the web page 304 to the WWW server 104 of the advertiser A (at step 1109). When the WWW server 104 of the advertiser A receives the request for the web page 304, the WWW server 104 of the advertiser A transmits the web page 304 to the WWW browser 108 (at step 1110).

Thereafter, while the WWW browser 108 is displaying the web page 304, the user clicks the keyword A 304a (at step 111). Then, the WWW browser 108 transmits the request for a process responding to the clicking keyword A and the cookie of the user ID to the portal WWW server 102 (at step 1112).

When the portal WWW server 102 receives the request for the process responding to clicking the keyword A, the portal WWW server 102 starts the process responding to clicking the keyword A. In the process responding to clicking the keyword A, the portal WWW server 102 searches the database 102a for a record having the same user ID as the user ID transmitted as the cookie, obtains the current date and time data from the system clock of the portal WWW server 102, and writes the obtained date and time data to the keyword A click date/time field 21f of the searched record. This writing operation is referred to as event log recording operation. FIG. 22 shows an example of data of the resultant record. Thereafter, in the process responding to clicking the keyword A, the portal WWW server 102 reads data from the keyword A click date/time field 21f to the keyword D click date/time field 21i and counts the number of fields having the date and time data which is valid and is not earlier than the date and time earlier than the current date and time by a predetermined period (for example, one month), that is, is within a valid period. The portal WWW server 102 treats the number of such fields as acquired points and calculates insufficient points as the difference between predetermined target points necessary for the user to proceed to the quiz and the acquired points.

In this example, it is assumed that the acquired points do not reach the target points at present.

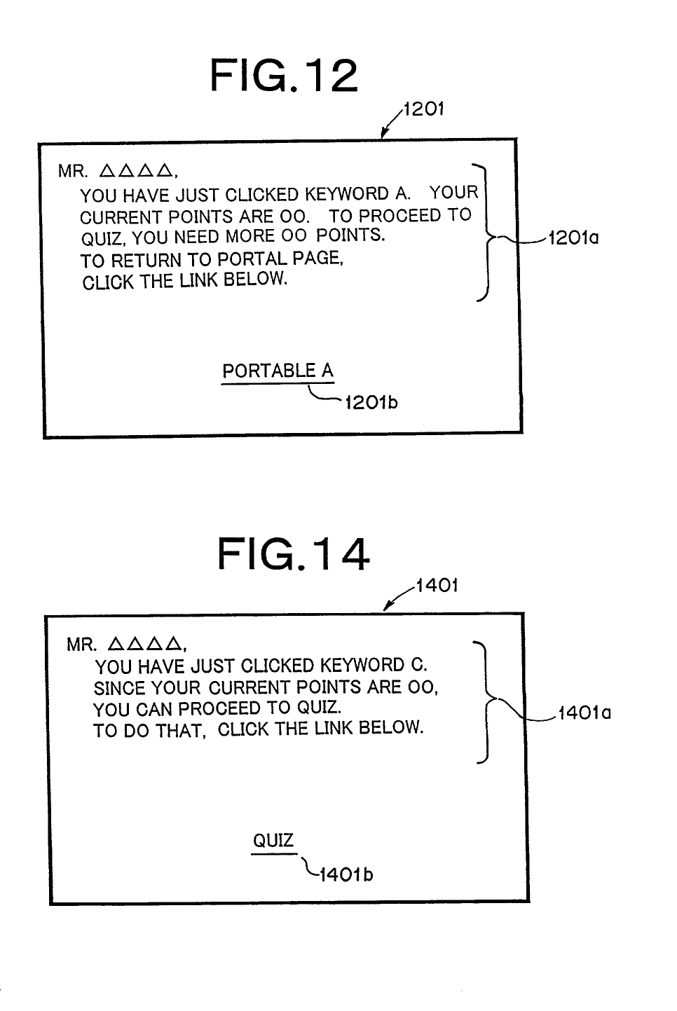

After the portal WWW server 102 has completed the process responding to clicking the keyword A, the portal WWW server 102 transmits web page 1201 (see FIG. 12) notifying of the completion of the process responding to clicking the keyword A to the WWW browser 108 (at step 1114).

Referring to FIG. 12, the web page 1201 notifying of the completion of the process responding to clicking the keyword A contains a character string 1201a and a character string 1201b. The character string 1201a represents acquired points and insufficient points. The character string 1201b is associated with a hyperlink to the portal web page 201.

While the WWW browser 108 is displaying the web page 1201 notifying of the completion of the process responding to clicking the keyword A, the user clicks the character string 1201b (at step 1115). Then, the WWW browser 108 transmits the request for the portal web page 201 to the portal WWW server 102 (at step 1116).

When the portal WWW server 102 receives the request for the portal web page 201, the portal WWW server 102 transmits the portal web page 201 to the WWW browser 108 (at step 1117).

Next, the operation in the case that the user searches web pages provided by a WWW server of an advertiser for the final keyword will be described.

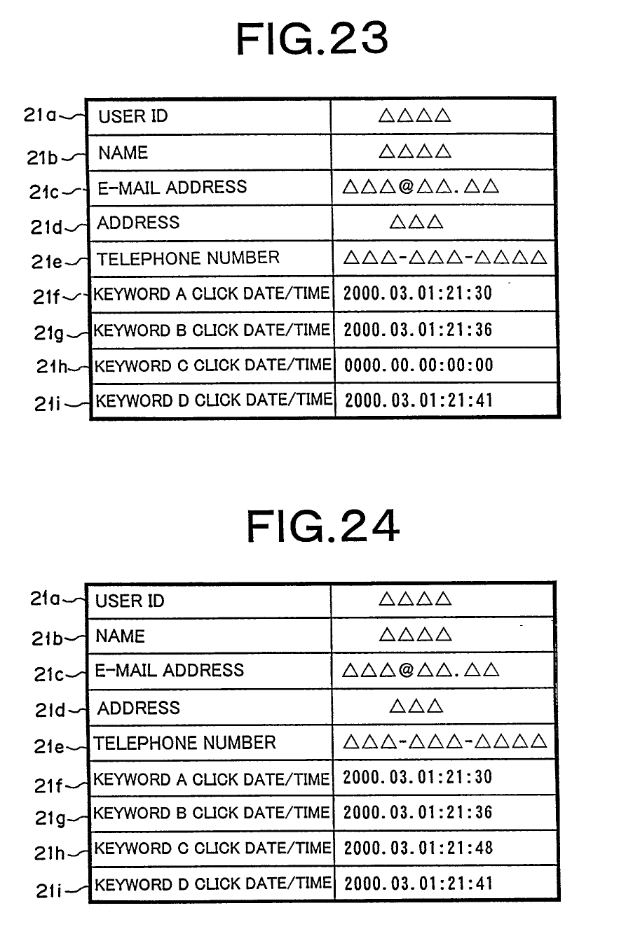

It is assumed that the use searches web pages provided by the WWW server 106 of the advertiser C for the final keyword. In this case, just before the user searches the web pages provided by the WWW server 106 of the advertiser C for the final keyword, each field of a record for the user stored in the database 102a stores data as shown in FIG. 23. In other words, the keyword A click date/time field 21f stores “2000.03.01 : 21:30” as the date and time at which the user has clicked the keyword A 403a. The keyword B click date/time field 21g stores “2000.03.01 : 21:36” as the date and time at which the user has clicked the keyword B 602a. The keyword D click date/time field 21i stores “2000.03.01 : 21:41” as the date and time at which the user has clicked the keyword D 602a. The keyword C click date/time field 21h stores invalid data because the user has not yet clicked the keyword C 503a.

Referring to FIG. 13, while the WWW browser 108 is displaying the portal web page 201 (at step 1301), the user clicks the advertisement banner 201c (at step 1302). Then, the WWW browser 108 transmits the request for the home web page 501 of the advertiser C to the WWW server 106 of the advertiser C (at step 1303). When the WWW server 106 of the advertiser C receives the request for the home web page 501, the WWW server 106 transmits the home web page 501 to the WWW browser 108 (at step 1304).

Thereafter, while the WWW browser 108 is displaying the home web page 501, the user clicks a hyperlink (not shown) to the second web page 502 of the advertiser C (at step 1305). Then, the WWW browser 108 transmits the request for the web page 502 to the WWW server 106 of the advertiser C (at step 1306). When the WWW server 106 of the advertiser C receives the request for the web page 502, the WWW server 106 transmits the web page 502 to the WWW browser 108 (at step 1307).

Thereafter, while the WWW browser 108 is displays any web page of the advertiser C, the user clicks a hyperlink (not shown) to the n_{c}-th web page 503 of the advertiser C (at step 1308). Then, the WWW browser 108 transmits the request for the web page 503 to the WWW server 106 of the advertiser C (at step 1309). When the WWW server 106 receives the request for the web page 503, the WWW server 106 transmits the web page 503 to the WWW browser 108 (at step 1310).

Thereafter, while the WWW browser 108 is displaying the web page 503, the user clicks the keyword C 503a (at step 1311). Then, the WWW browser 108 transmits the process responding to clicking the keyword C and the cookie of the user ID to the portal WWW server 102 (at step 1312).

When the portal WWW server 102 receives the request for the process responding to clicking the keyword C, the portal WWW server 102 starts the process responding to clicking the keyword C (at step 1313). Here, in a supposed case where the user clicks the keyword C 503a as a non-final keyword among the keyword A 504a, the keyword B 403a, the keyword C 503a, and the keyword D 602a, that is, in a different case, the keyword C clicking process (at step 1313) is the same as the keyword A clicking process (at step 1113).

The portal WWW server 102 searches the database 102a for a record having the same user ID as the user ID transmitted as the cookie along with the request for the process responding to clicking keyword C, obtains the current date and time data from the system clock of the portal WWW server 102, and writes the obtained date and time data to the keyword C click date/time field 21h of the searched record. FIG. 24 shows an example of data after this writing. Thereafter, in the process responding to clicking the keyword C (at step 1313), the portal WWW server 102 reads the keyword A click date/time data 21f to the keyword D click date/time data 21i, counts the number of keywords that are valid and are not earlier than the date and time earlier than the current date and time data by a predetermined period, treats the number of counted keywords as acquired points, and calculates insufficient points as the difference between the predetermined target points necessary for the user to proceed to the quiz and the acquired points.

In this example, it is assumed that the acquired points reach the target points now.

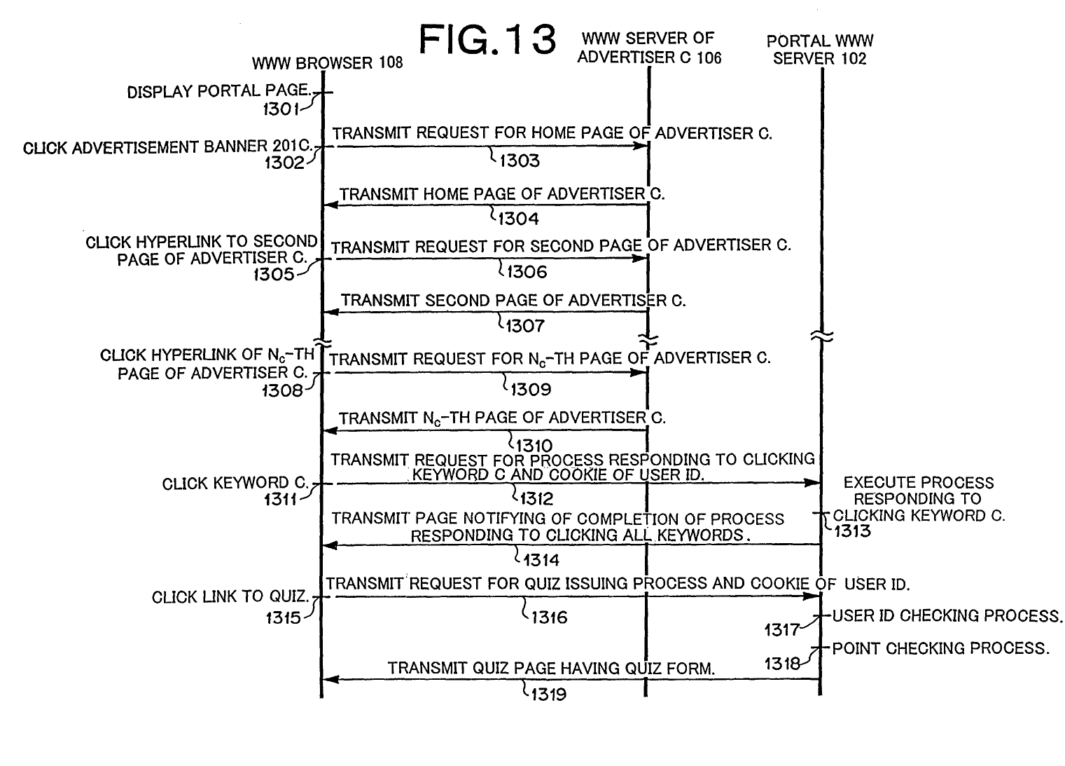

After the portal WWW server 102 has completed the process 1313 for clicking the keyword C, the portal WWW server 102 transmits web page 1401 (see FIG. 14) notifying of the completion of clicking all the keywords to the WWW browser 108 (at step 1314).

Referring to FIG. 14, the web page 1401 notifying of the completion of clicking all the keywords contains a character string 1401a and a character string 1401b. The character string 1401a represents that the acquired points reach the target points and the user can proceed to the quiz. The character string 1401b is associated with a hyperlink to the quiz web page 1501.

While the WWW browser 108 is displaying the web page 1401 notifying of the completion of clicking all the keywords, the user clicks the character string 1401b (at step 1315). Then, the WWW browser 108 transmits a request for a quiz issuing process using CGI, Java Servlet, or the like and a cookie of the user ID to the portal WWW server 102 (at step 1316).

When the portal WWW server 102 receives the request for the quiz issuing process, the portal WWW server 102 checks the user ID contained in the cookie (at step 1317), searches the database 102a for a record having the same user ID as the user ID transmitted as the cookie, checks the keyword A click date/time 21f to the keyword D click date/time 21i stored in the record to determine whether the acquired points have reached the target points (at step 1318). When the determined result is Yes, the portal WWW server 102 transmits a quiz web page 1501 to the WWW browser 108 (at step 1319).

Referring to FIG. 15, the quiz web page 1501 contains a quiz form 1501a. The quiz form 1501a contains question answer groups 1501b, 1501c, 1501d, and 1501e, a user ID 1501f, a reset button 1501g, and a submit button 1501h. The answer group 1501b is composed of a question A about the keyword A 304a and a set of alternative answers to the question A. The answer group 1501c is composed of a question B about the keyword B 403a and a set of alternative answers to the question B. The answer group 1501d is composed of a question C about the keyword C 503a and a set of alternative answers to the question C. The answer group 1501e is composed of a question D about the keyword D 602a and a set of alternative answers to the question D. The user ID 1501f is hidden in the quiz form 1501a. The reset button 1501g is used to clear all the answers that the user has selected with the radio buttons. The submit button 1501h is used to transmit the quiz form 1501a containing form information composed of the answers and user ID to the portal WWW server 102.

The contents of the questions about the individual keywords are so simple that the advertisers can easily know the advertisement effects. For example, as a question, “what company has released an extra dry beer that is new, inexpensive, and favorite?”. The answer could be “A—ABC Brewery, B—DEF Publishing Company, C—MEC”. Alternatively, the answer could be “A—ABC Brewery, B—HIJ Brewery, C—PQR Brewery”.

Next, the operation starting with the transmission of the quiz web page 1501 to the WWW browser 108 will be described.

First, the operation in the case that the number of correct answers of the user is equal to or more than a predetermined value will be described.

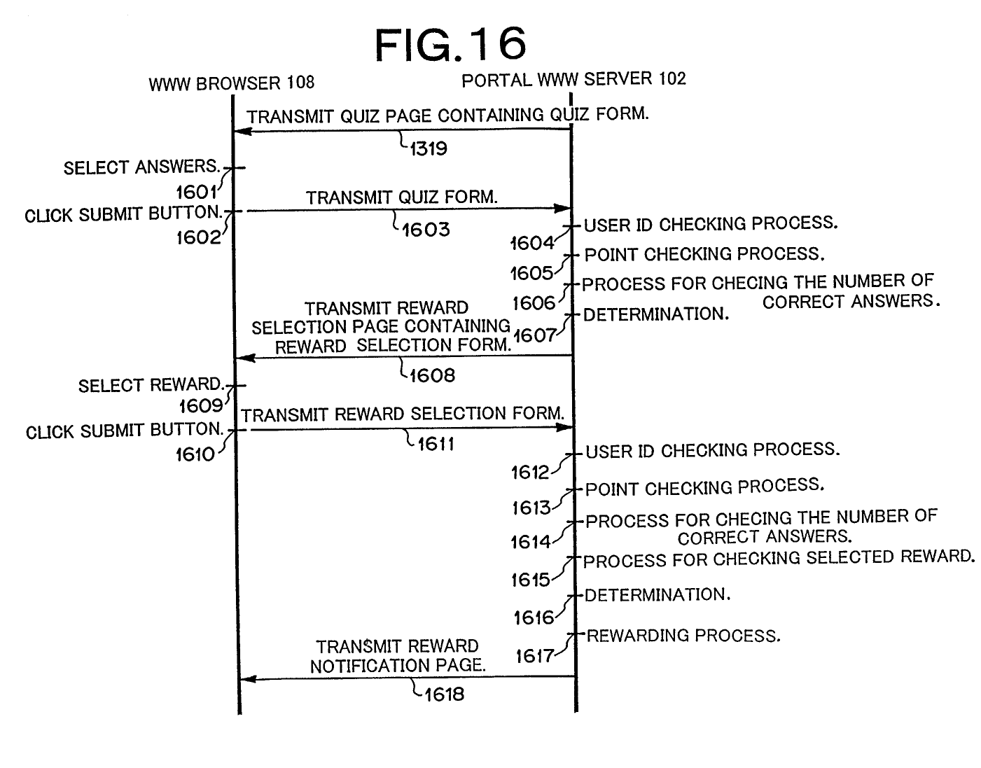

Referring to FIG. 16, the quiz web page 1501 is transmitted from the portal WWW server 102 to the WWW browser 108 (at step 1319). While the WWW browser 108 is displaying the quiz web page 1501, the user selects answers (at step 1601) and presses the submit button 1501h. Then, the WWW browser 108 transmits the quiz form 1501a containing the form information composed of the answers and the user ID to the portal WWW server 102.

When the portal WWW server 102 receives the quiz form 1501a, the portal WWW server 102 checks the user ID in the form information contained in the quiz form 1501a (at step 1604), checks the keyword A click date/time 21f to the keyword D click date/time 21i of the record of the database 102a having the same user ID as the user ID contained in the form information received along with the quiz form 1501a to count the acquired points (at step 1605), checks the selected answers to count the number of correct answers (at step 1606), and determines whether or not the number of acquired points reaches the predetermined value and the number of correct answers reaches the predetermined value (at step 1607). When the determined result at step 1607 is Yes, the portal WWW server 102 transmits the reward selection web page 1701 (see FIG. 17) to the WWW browser 108 (at step 1608).

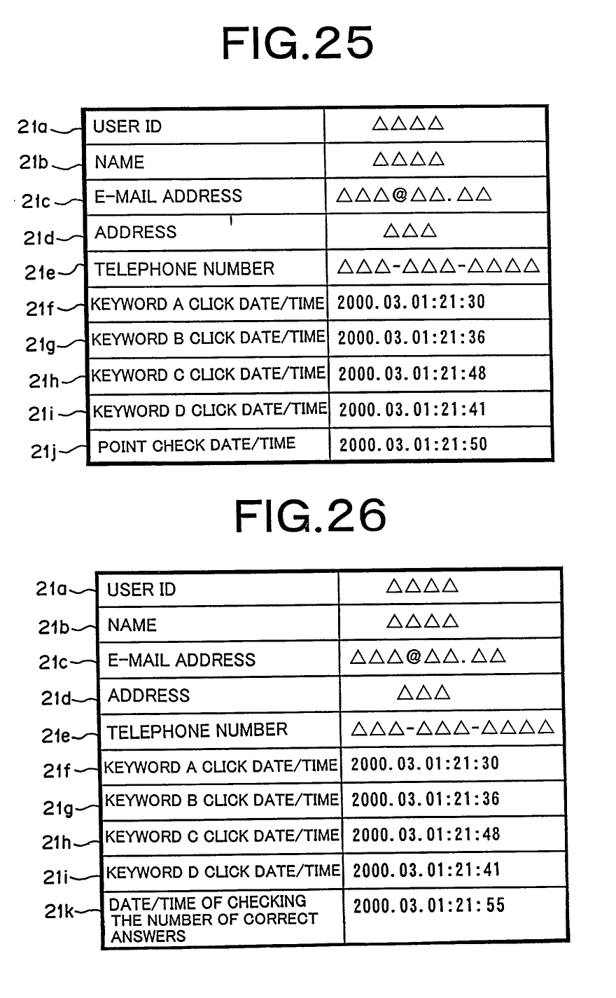

Here, instead of performing the point checking process (at step 1605), the result of the point checking process (at step 1318) may be quoted using flag operation and database. If the database is used, a point check date/time field 21j is placed in the database 102a as shown in FIG. 25. In the point checking process at step 1318, when the acquired points reach the predetermined points, the current date and time data is recorded to the point check date/time field 21j. At the same timing as the point checking process (at step 1605), the date and time data stored in the point check date/time field 21j is checked. When the date and time data stored in the point check date/time field 21j is invalid or earlier than the date and time earlier than the current date and time data by a predetermined period, it is determined that the acquired points do not reach the predetermined points. Otherwise, it is determined that the acquired points reach the predetermined points.

Referring to FIG. 17, the reward selection web page 1701 contains a character string 1701a and a reward selection form 1701b. The character string 1701a represents that the number of correct answers reaches the predetermined value. The reward selection form 1701b contains a radio button group 1701c, a user ID 1701d, a reset button 1701e, and a submit button 1701f. The radio button group 1701c contains radio buttons with which the user selects a reward. The user ID 1701d is hidden in the reward selection web page 1701. The reset button 1701e is used to cancel the selections of all the radio buttons. The submit button 1701f is used to transmit the reward selection form 1701b along with the form information composed of the user ID and the ID of the selected radio button.

Returning to FIG. 16, while the WWW browser 108 is displaying the reward selection web page 1701 after the WWW browser 108 has received the reward selection web page 1701, the user selects a reward (at step 1609) and clicks the submit button 1701f (at step 1610). Then, the WWW browser 108 transmits the reward selection form 1701b containing the form information composed of the ID of the selected radio button and the user ID to the portal WWW server 102 (at step 1611).

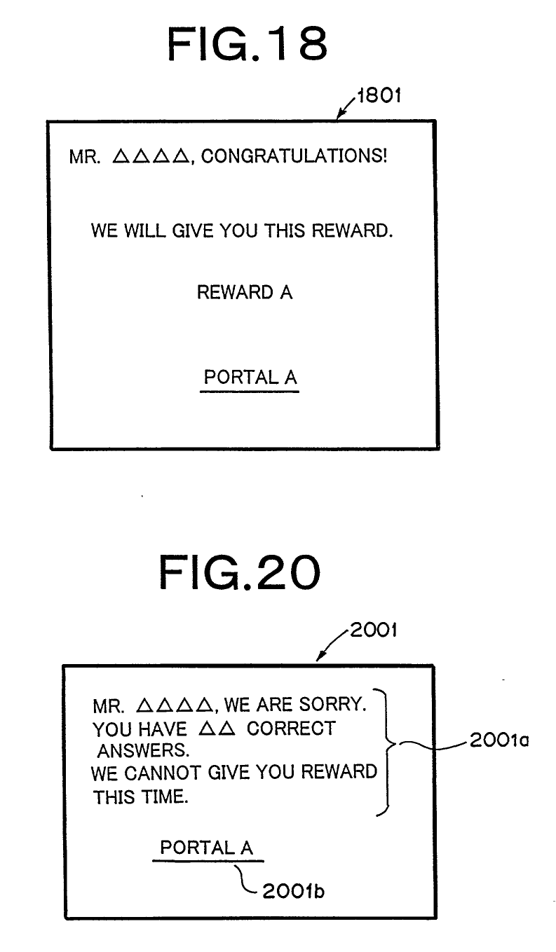

When the portal WWW server 102 receives the reward selection form 1701b, the portal WWW server 102 checks the user ID contained in the form information received along with the reward selection form 1701b (at step 1612), checks the keyword A click date/time 21f to the keyword D click date/time 21i in the record of the database 102a having the same user ID as the user ID contained in the form information received along with the reward selection form 1701b to check the acquired points (at step 1613), checks the selected answers of the quiz form 1501a to check the number of correct answers (at step 1614), checks the selected reward (at step 1615), and determines whether or not the acquired points reach the predetermined value and the number of correct answers reaches the predetermined value (at step 1616). When the determined result at step 1616 is Yes, the portal WWW server 102 performs the rewarding process (at step 1617) and transmits a reward notification web page 1801 (see FIG. 18) to the WWW browser 108 (at step 1618).

In the rewarding process (at step 1617), the portal WWW server 102 correlates the user ID with the selected reward contained in the form information of the reward selection form 1701b and records them to the database 102b. As shown in FIG. 27, each record of the database 102b contains a user ID field 27a and a reward field 27b. Moreover, in the rewarding process (at step 1617), the portal WWW server 102 performs a reward shipment preparing computer process (for example, creates a shipment label (containing recipient name, address thereof, and reward name)), a computer process for an Internet connection fee database (not shown), and a double reward prevention process.

In the case that the provider WWW server 103 has the connection fee database, when necessary, information such as the user ID, the user information, and the reward contents is transmitted from the portal WWW server 102 to the provider WWW server 103.

If the provider cooperates with the portal WWW server or they are integrated, the user ID may be the same as the member ID in the provider.

Here, instead of performing the point checking process (at step 1613), the result of the point checking process (at step 1318) may be quoted using flag operation and database. If the database is used, the point check date/time field 21j is placed in the database 102a as shown in FIG. 25. When the acquired points reach the predetermined points in the point checking process at step 1318, the current date and time data is stored to the point check date/time field 21j. At the same timing as the point checking process (at step 1613), the date and time data stored in the point check date/time field 21j is checked. When the date and time data stored in the point check date/time field 21j is invalid or earlier than the date and time earlier than the current date and time data by a predetermined period, it is determined that the acquired points do not reach the predetermined points. Otherwise, it is determined that the acquired points reach the predetermined points.

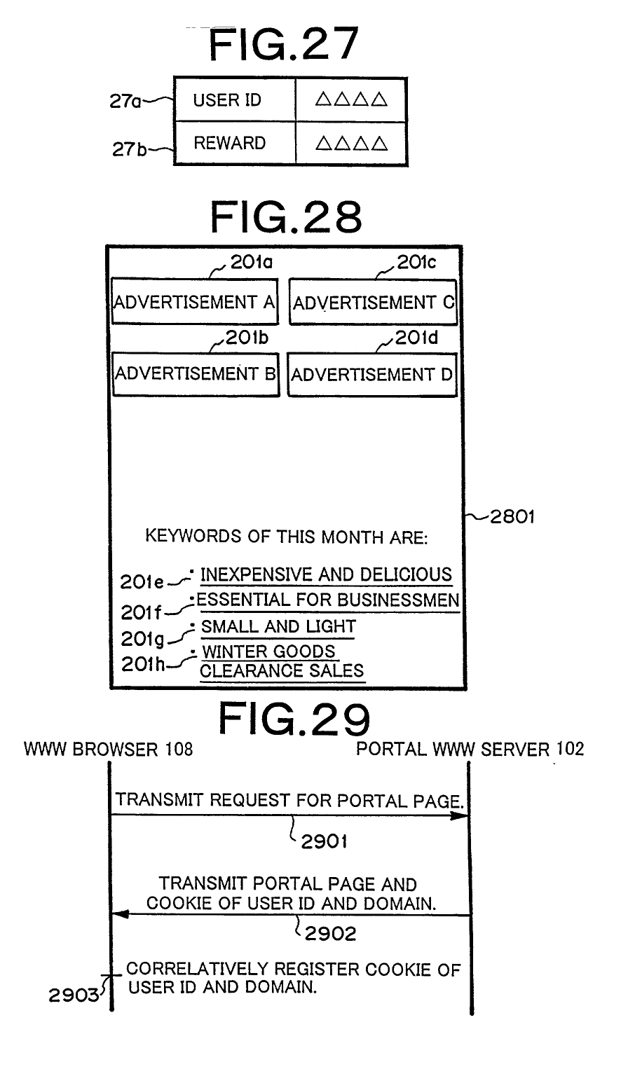

Instead of performing the process (at step 1614) of checking the number of correct answers, the result of the process (at step 1606) of checking the number of correct answers may be quoted using flag operation and database. If the database is used, a field 21k of the date and time when checking the number of correct answers is placed in the database 102a as shown in FIG. 26. When the number of correct answers reaches the predetermined value in the process at step 1606 of checking the number of correct answers, the current date and time data is stored to the field 21k of the date and time when checking the number of correct answers. At the same timing as the process at step 1614 of checking the number of correct answers, the date and time data stored in the field 21k of the date and time when checking the number of correct answer is checked. When the date and time data stored in the field 21j of the date and time when checking the number of correct answer is invalid or earlier than the date and time earlier than the current date and time data by a predetermined period, it is determined that the number of correct answers do not reach the predetermined value. Otherwise, it is determined that the number of correct answer reach the predetermined value.

Next, the operation in the case that the number of correct answers do not reach the predetermined value will be described.

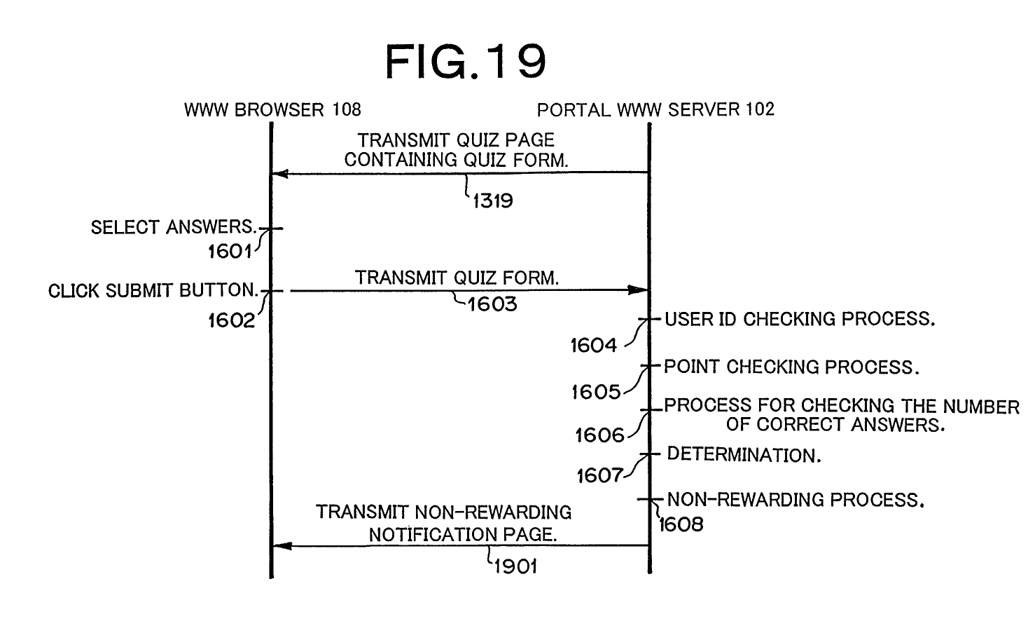

Since steps 1319 and 1601 to 1607 shown in FIG. 19 are same as steps 1319 and 1601 to 1607 shown in FIG. 16, their description will be omitted.

When the determined result at step 1607 is No, the portal WWW server 102 transmits a non-reward notification web page 2001 (see FIG. 20) to the WWW browser 108 (at step 1901).

Referring to FIG. 20, the non-reward notification web page 2001 contains a character string 2001a and a character string 2001b. The character string 2001a represents that the user cannot be rewarded. The character string 2001b is associated with a hyperlink to the portal web page 201.

In the above description, the portal WWW server 102 is separated from the provider WWW server 103. Alternatively, the provider WWW server 103 may be disposed at the position of the portal WWW server 102 so that the provider WWW server 103 has the function of the portal WWW server 102.

In the above description, it is determined whether or not the predetermined number of keywords have been clicked in a predetermined period by managing date and time data when the keywords are clicked. Instead of the keyword A click date/time field 21f to the keyword D click date/time field 21i, a keyword A click flag to a keyword D click flag may be used as fields of the database 102a. For example, these flags of all users may be reset every month. When a particular user clicks a particular keyword, the flag of the field corresponding to the keyword of the record of the user may be set.

### Second Embodiment

According to the first embodiment, before the user searches for a keyword, user information is recorded to the database 102a of the portal WWW server 102 in the sequence shown in FIG. 7. According to the second embodiment, the user searches for a predetermined number of keywords and answers quizzes before inputting user information. When the user has searched for the predetermined number of keywords and the number of correct answers exceeds a predetermined value, the user is requested to input user information. Then the user information is recorded to the database 102a of the portal WWW server 102. According to the second embodiment, a situation that user information is transmitted to the portal WWW server but the user is not rewarded can be prevented. Thus, the user can be prevented from hesitating to start searching for keywords.

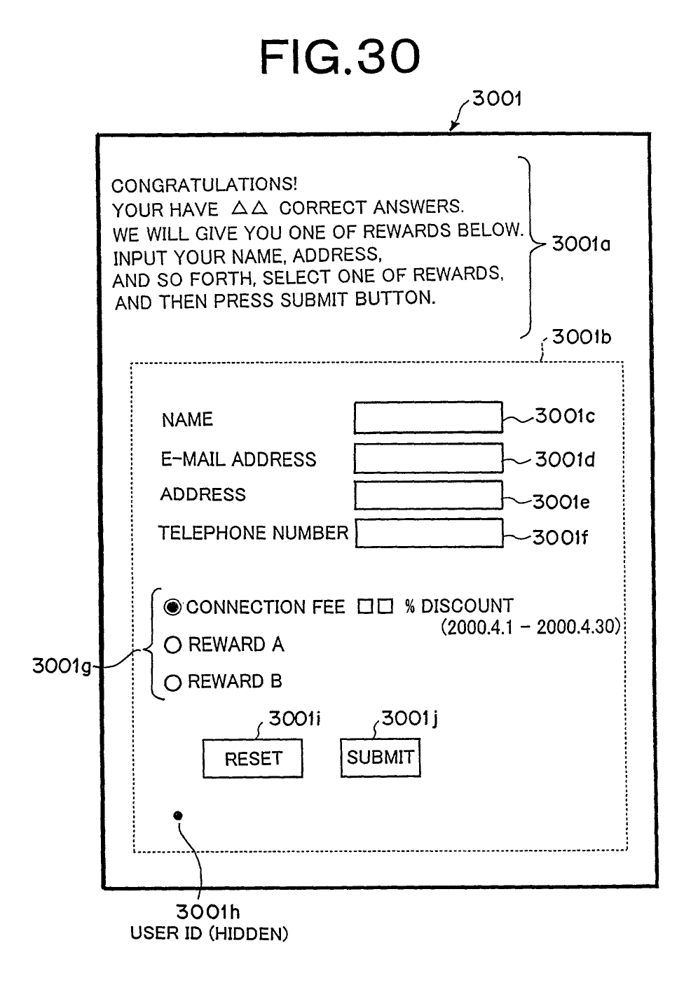

According to the second embodiment, the operation shown in FIG. 7 is not performed. Instead, an operation shown in FIG. 29 is performed. In addition, the portal page 201 is substituted with a portal page 2801 as shown in FIG. 28. The portal page 2801 is different from the portal page 201 in that the character string “user registration” 201i is omitted.

Referring to FIG. 29, when the user clicks an object hyperlinked to the portal page 2801 or inputs the URL of the portal page 2801 on the WWW browser 108, the WWW browser 108 transmits a request for the portal page 2801 to the portal WWW server 102 (at step 2901). When the portal WWW server 102 receives the request for the portal page 2801, the portal WWW server 102 transmits a cookie of a user ID the domain name of the portal WWW server 102 (see FIG. 10A) and the portal page 2801 to the WWV browser 108 (at step 2902). When the WWW browser 108 receives the portal page 2801 and the cookie of the user ID and the domain name of the portal WWW server 102, the WWW browser 108 displays the portal page 2801 and correlatively registers the domain name of the portal WWW server 102 and the user ID to a record medium (not shown) such as a hard drive in the format, for example, shown in FIG. 10B (at step 2903).

According to the second embodiment, at step 1608, the portal WWW server transmits user information input and reward selection web page 3001 as shown in FIG. 30 instead of the reward selection web page 1701 shown in FIG. 17. The web page 3001 contains a character string 3001a and a form 3001b. The character string 3001a represents that the number of correct answers reaches a predetermined value and prompts the user to input user information and to select a reward. The form 3001b is a combination of the user registration form 801a shown in FIG. 8 and the form 1701b shown in FIG. 17. The form 3001b contains a text box 3001c, a text box 3001d, a text box 3001e, a text box 3001f, a radio button group 3001g, a user ID 3001h, a reset button 3001i, and a submit button 3001j. The text box 3001c is used to input a name. The text box 3001d is used to input an e-mail address. The text box 3001e is used to input an address. The text box 3001f is used to input a telephone number. The radio button group 3001g is used to select a reward. The user ID 3001h is hidden in the form 3001b. The reset button 3001i is used to erase characters that have been input in the text boxes and clear the selections of all the radio buttons. The submit button 3001j is used to transmit the form 3001b, together with form information containing user information, the user ID, and the ID of the selected radio button to the portal WWW server 102.

According to the second embodiment, in the rewarding process (at step 1617), the portal WWW server 102 not only performs the same process as the first embodiment and but records the user information transmitted as form information received along with the form 3001b to the name field 21b, the e-mail address field 21c, the address field 21d, and the telephone number field 21e (see FIG. 21) of a record of the database 102a having the same user ID as the received user ID.

### Third Embodiment

Depending on the type of the WWW browser 108 and the settings of options thereof, it does not record a cookie.

Unless the WWW browser 108 records a cookie, the first embodiment and the second embodiment cannot be realized. In contrast, even if the WWW browser 108 does not record a cookie, a third embodiment of the present invention can be realized.

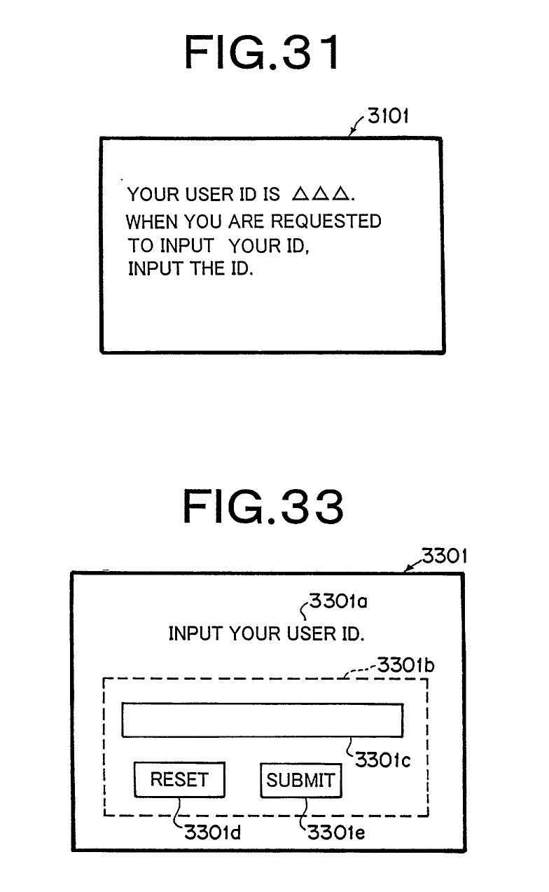

The third embodiment is based on the first embodiment. At step 711 (see FIG. 7), the portal WWW server 102 transmits the web page 901 (see FIG. 9) and a web page 3101 (see FIG. 31) to the WWW browser 108. When the WWW browser 108 receives the web page 901 and the web page 3101, it displays these pages. The user memorizes the user ID displayed on the web page 3101. Alternatively, the user keeps the web page 3101 open.

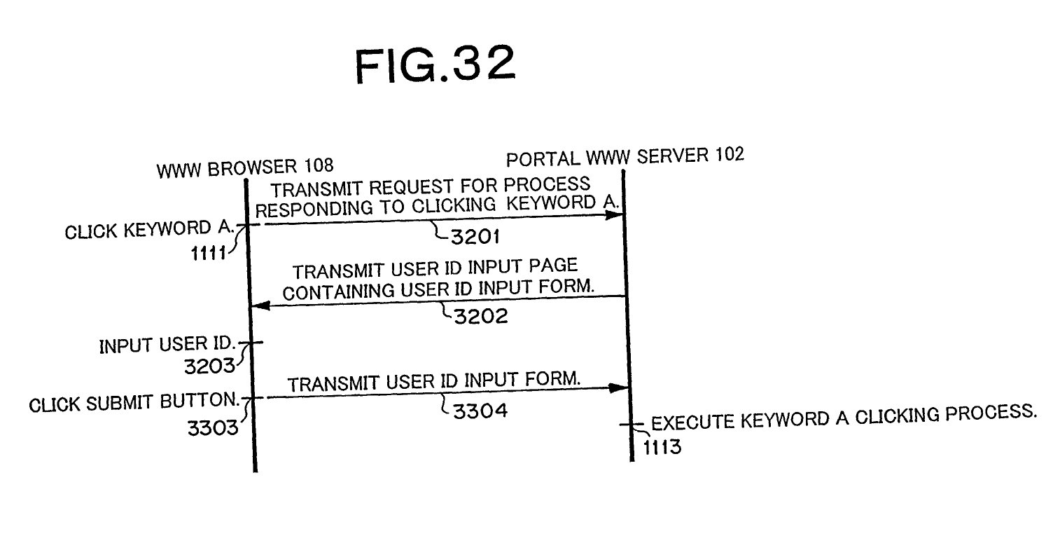

Referring to FIG. 32, in the case that the WWW browser 108 does not record a cookie, when the user clicks the keyword A on the WWW browser 108 (at step 1111), only a request for the process responding to clicking the keyword A is transmitted to the portal WWW server 102 (at step 3201). Thus, a cookie of the user ID is not transmitted.

When the portal WWW server 102 has determined that a cookie had not been transmitted at step 3201 along with the request for the process responding to clicking the keyword A, the portal WWW server 102 transmits a web page 3301 (see FIG. 33) to the WWW browser 108 (at step 3202) before performing the keyword process (at step 1113).

The web page 3301 contains a character string 3301a and a form 3301b. The character string 3301a prompts the user to input a user ID. The form 3301b contains a text box 3301c, a reset button 3301d, and a submit button 3301e. The text box 3301c is used to input a user ID. The reset button 3301d is used to erase a character string that has been input to the text box 3301c. The submit button 3301e is used to transmits a character string that has been input to the text box 3301c.

When the WWW browser 108 displays the web page 3301, the user inputs the user ID that he or she has memorized or that is displayed on the web page 3101 to the text box 3301c (at step 3203) and then clicks the submit button 3301e (at step 3303). When the user clicks the submit button 3301e, the WWW browser 108 transmits a user ID input form and the user ID to the portal WWW server 102 (at step 3304). When the portal WWW server 102 receives the user ID, the portal WWW server 102 executes the process (at step 1113) for clicking the keyword A.

When the user clicks the keyword C (at step 1311 shown in FIG. 13) and the link to the quiz (at step 1315 shown in FIG. 13), a cookie is not transmitted. However, owing to performing the process shown in FIG. 32, the portal WWW server 102 obtains the user ID and proceeds to the next process.

### Fourth Embodiment

The first embodiment is modified to the third embodiment to cope with a case where the WWW browser 108 does not record a cookie. Similarly, the second embodiment is modified to the fourth embodiment to cope with the case where the WWW browser 108 does not record a cookie.

According to the third embodiment, at step 711 (see FIG. 7), the portal WWW server 102 transmits the web page 901 (see FIG. 9) and the web page 3101 (see FIG. 31) to the WWW browser 108. Similarly, according to the fourth embodiment, at step 2902 (see FIG. 29), the portal WWW server 102 transmits the web page 3001 (see FIG. 30) and the web page 3101 (see FIG. 31) to the W browser 108.

Since the difference between the second embodiment and the fourth embodiment except for the above point is the same as the difference between the first embodiment and the third embodiment, the description thereof is omitted.

### Fifth Embodiment

According to the first and second embodiments, a cookie is composed of a user ID and a domain name. Because an event log is not recorded as a cookie of the WWW browser, but is recorded to the database 102a of the portal WWW server 102, the event log is prevented from being falsified by a user.

However, when one user performs the rewarding process with different user IDs recorded in the WWW browser 108, the user may obtain rewards for a plurality of people. According to the fifth embodiment, such a problem can be prevented.

According to the fifth embodiment, an event log is encrypted in such a manner that the encrypted event log cannot be decrypted without a user ID. The encrypted event log is recorded as a cookie to the WWW browser 108. For example, the date and time data when the keyword A is clicked is transmitted as the following cookie from the portal WWW server 102 to the WWW browser 108.

ClickTimeOfKeyWordA=aocjez83kb

Thus, even if a cookie of a user ID is falsified, since the cookie of the event log does not match the cookie of the user ID, the portal WWW server 102 can detect a falsified user ID.

In addition, because the event log is recorded to the WWW browser 108, the point counting process and so forth can be performed with a script such as JavaScript or an applet such as JavaApplet that operates on the WWW browser 108.

### Sixth Embodiment

If the portal WWW server 102 is cooperated with a provider or they are integrated in the first to fourth embodiments, a member ID of the provider may be used as a user ID. Especially, when the sixth embodiment is based on the third or fourth embodiment, it is not necessary for the user to memorize or reference the user ID. Thus, the sixth embodiment is effective.

### Seventh Embodiment

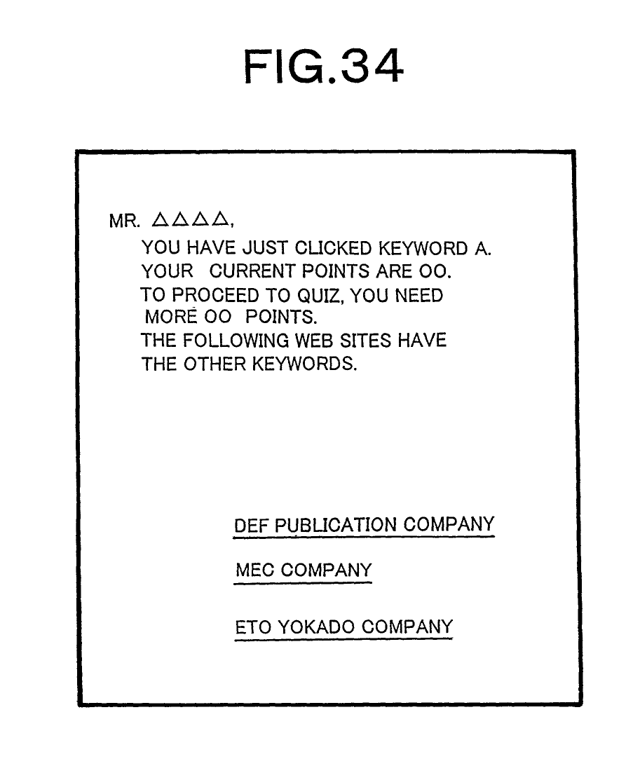

According to the first embodiment, the web page 1201 for notifying of the completion of clicking the keyword A transmitted at step 1114 is hyperlinked to only the portal web page 201. In contrast, according to the seventh embodiment, as shown in FIG. 34, the keyword A clicking process completion notification web page 1201 is also hyperlinked to web pages of other advertisers. As a result, it is not necessary for the user to return to the portal web page 201 whenever he or she searches for a keyword. In addition, by referring to the event log of each keyword stored in a record of the database 102a, only home pages which has a keyword which has not been clicked in a valid period can be hyperlinked.

### Eighth Embodiment

According to the first to seventh embodiments, after the number of keywords that the user has clicked reaches a predetermined value, before he or she selects a reward, he or she must answer quizzes. In contrast, according to an eighth embodiment, just after the number of keywords that the user has clicked reaches a predetermined number, the user can select a reward without need to answer any quiz.

### Ninth Embodiment

According to the first to eighth embodiments, only when the number of keywords that the user has clicked reaches a predetermined value, he or she can proceed to a quiz. In contrast, according to a ninth embodiment, corresponding to the number of keywords that the user has clicked, the type of a reward that the user can obtain is changed.

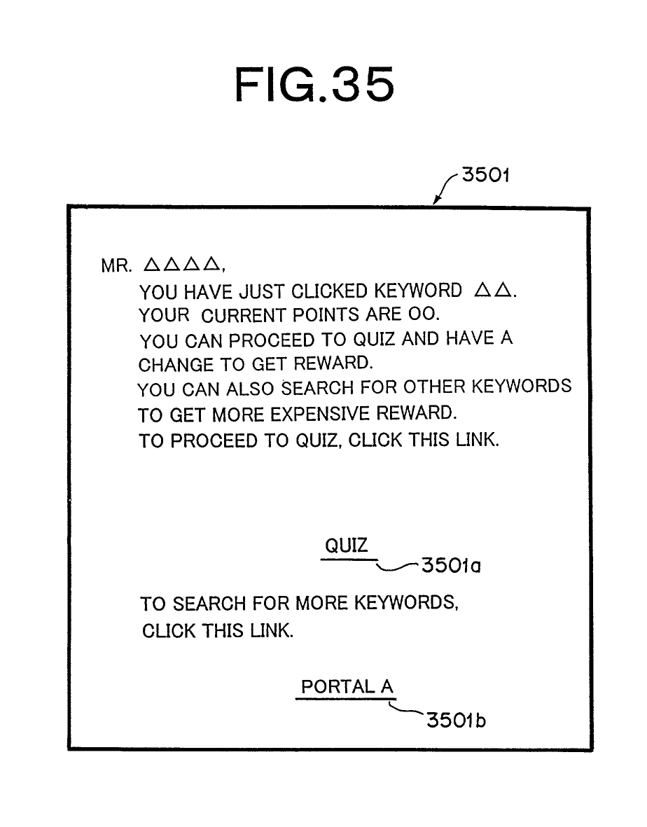

According to the ninth embodiment, a web page shown in FIG. 35 is transmitted at step 1114 or step 1314. If the user clicks a link character string 3501a on the WWW browser 108, the flow advances to step 1316. If the user clicks a link character string 3501b on the WWW browser 108, the flow advances to step 1116. The quiz page 1501 (see FIG. 15) that the portal WWW server 102 transmits to the W browser 108 at step 1319 (see FIGS. 13 and 16) is changed depending on the number of clicked keywords. In addition, the reward selection web page 1701 (see FIG. 17) that the portal WWW server 102 transmits to the WWW browser 108 at step 1608 is changed depending on the number of clicked keywords.

### Tenth Embodiment

According to the first to eighth embodiments, when the number of correct answers that the user has selected reaches a predetermined value, he or she can select one of a plurality of rewards. In contrast, according to a tenth embodiment, the types of rewards that the user can obtain are changed depending on the number of correct answers.

According to the tenth embodiment, the reward selection web page 1701 (see FIG. 17) that the portal WWW server 102 transmits to the WWW browser 108 is changed depending on the number of correct answers.

### Eleventh Embodiment

According to the first to tenth embodiments, when a predetermined keyword is clicked on a web page, an event log is recorded so that acquired points are updated. Alternatively, when a picture, a mark, or the like on a web page rather than a keyword is clicked, an event log may be recorded so that the acquired points are updated.

According to the present invention, a character string of a keyword, a picture equivalent to a keyword, a mark equivalent to a keyword, and so forth are generally referred to as objects.

### Twelfth Embodiment

According to the first to eleventh embodiments, user information is used for only an address to which a reward is shipped. In contrast, according to a twelfth embodiment, user information of a plurality of users is totalized so that it can be used as materials for researching advertisement effects, tendencies of consumers, and so forth. In this case, user information may contain sex, age, hobbies, and so forth of the user.

As described above, according to the present invention, advertisers, advertisement sites, browsing users, and providers have the following advantages.

The advertisers only need to provide keywords to their advertisement sites. They do not need to create fanciful banners, marks, and pictures necessary for advertisements. As a result, the cost for preparing advertisements can be reduced.

The browsing users join keyword searches. Thus, they carefully watch individual home pages. As a result, advertisement effects becomes high.

The browsing users actively watch advertisements of the advertisement sites for rewards. Thus, the value as an advertisement medium becomes high. As a result, since the advertisement sites can charge advertisers for higher advertisement fees, the advertisement incomes increase.

The browsing users can enjoy searching web pages of advertisers for keywords. When the browsing users can find all keywords, they can get rewards.

The advertisement sites and the providers that operate the sites provide rewards such as a discount of connection fee. Thus, they can acquire more subscribers. As a result, they can have a large share in the market.

Although the present invention has been shown and described with respect to the best mode embodiment thereof, it should be understood by those skilled in the art that the foregoing and various other changes, omissions, and additions in the form and detail thereof may be made therein without departing from the spirit and scope of the present invention.

What is claimed is:

1. A rewarding method corresponding to an object selection on a web page, comprising the steps of:
(a) designating a predetermined object to each of a plurality of web pages having respective uniform resource locators (URLs);
(b) causing a server to detect that a user of a user terminal unit has selected the object on one of the plurality of web pages having respective URLs;
(c) recording an event log correlating an identifier of the user, an identifier of the selected object, and an event that the object has been selected, when the server detects that the user of the user terminal unit has selected the object;
(d) determining whether or not the number of objects recorded in the event log exceeds a first predetermined value; and
(e) performing a rewarding process to reward the user when the determined result at the step (d) is Yes.

2. The rewarding method as set forth in claim 1, wherein when the determined result at the step (d) is Yes, before performing the step (e), a quiz web page is displayed on the user terminal unit, and
wherein when the number of correct answers that the user have input to the user terminal unit in response to the quizzes on said quiz web page is greater than a second predetermined value, the step (e) is performed.

3. The rewarding method as set forth in claim 1,
wherein a link object of a web page provided by the server is hyperlinked to any web page, URL of which contains a server name contained in the URL of one of the plurality of web pages which have the predetermined objects designated.

4. The rewarding method as set forth in claim 3,
wherein the link object is a banner.

5. The rewarding method as set forth in claim 1,
wherein the server names contained in the plurality of URLs are different from each other.

6. The rewarding method as set forth in claim 5,
wherein a web page that contains a server name contained in one of the plurality of URLs is hyperlinked to a web page that contains a server name contained in another URL.

7. The rewarding method as set forth in claim 1, further comprising the steps of
(f) transmitting the identifier of the user from the server to the user terminal unit; and
(g) causing the user terminal unit to store the identifier of the user,
wherein the step (b) is preceded by the steps (f) and (g), and
wherein when the user of the user terminal unit has selected an object of a web page designated by one of the plurality of URLs, the user terminal unit transmits the identifier of the user stored therein to the server.

8. The rewarding method as set forth in claim 1, further comprising the steps of:
(h) transmitting the identifier of the user from the server to the user terminal unit; and
(i) causing the user terminal unit to display the identifier of the user,
wherein the step (b) is preceded by the steps (h) and (i), and
wherein when the user of the user terminal unit has selected an object of a web page designated by one of the plurality of URLs, the user terminal unit transmits the identifier of the user that has been input to the terminal unit by the user to the server.

9. The rewarding method as set forth in claim 1,
wherein the user terminal unit is a WWW browser.

10. The rewarding method as set forth in claim 1,
wherein the rewarding process is a computer-implemented process for shipping a reward.

11. The rewarding method as set forth in claim 1,
wherein the rewarding process is a computer-implemented process for discounting an Internet connection fee.

12. The rewarding method as set forth in claim 1,
wherein host names in the URLs are WWW server names of advertisers.

13. The rewarding method as set forth in claim 1,
wherein the server is a WWW server.

14. The rewarding method as set forth in claim 13,
wherein the server is a WWW server of a portal site.

15. The rewarding method as set forth in claim 13,
wherein the server is a WWW server of a provider.

16. The rewarding method as set forth in one of claims 1,
wherein the object is one of a character string, a picture, or a symbol.

17. The rewarding method as set forth in claim 1,
wherein the object is an advertisement.

18. The rewarding method as set forth in claim 1, further comprising the step of:
(j) totalizing the event log.

19. The rewarding method as set forth in claim 1,
wherein the event log is recorded to the server.

20. The rewarding method as set forth in claim 1,
wherein the event log is recorded to the user terminal unit.

21. The rewarding method as set forth in claim 20, further comprising the step of:
(k) encrypting the event log recorded to the user terminal unit.

22. The rewarding method as set forth in claim 1, further comprising the step of:
(l) transmitting user information from the user terminal unit to the server,
wherein the step (b) is preceded by the step (1).

23. The rewarding method as set forth in claim 1,
wherein the step (e) includes the step of
transmitting the user information from the user terminal unit to the server.

24. The rewarding method as set forth in claim 1,
wherein the plurality of URLs are changed to one predetermined URL.

25. A server, comprising:
recording means for recording an event log correlating the identifier of a user of a user terminal unit, an identifier of a selected object, and an event that the object has been selected when the user of the user terminal unit has selected one of predetermined objects on web pages designated with a plurality of predetermined uniform resource locators (URLs);
first determining means for determining whether or not the number of objects recorded in the event log exceeds a predetermined value; and
rewarding means for performing a rewarding process to reward the user when the determined result of said first determining means is Yes.

26. The server as set forth in claim 25, further comprising:
means for transmitting a quiz web page to the user terminal unit, when the determined result of said first determining means is Yes; and
second determining means for determining whether or not the number of correct answers among answers that have been transmitted from the user terminal unit as answers to the quizzes exceeds a second predetermined value,
wherein when the determined result of said first determining means is Yes and the determined result of said second determined means is Yes, said rewarding means rewards the user.

27. The server as set forth in claim 25,
wherein a link object of a web page provided by the server is hyperlinked to any web page, URL of which contains a server name contained in any URL among the plurality of predetermined URLs.

28. The server as set forth in claim 27,
wherein the link object is a banner.

29. The server as set forth in claim 25, further comprising:
means for transmitting the identifier of the user to the user terminal unit before said recording means operates.

30. The server as set forth in claim 25,
wherein said rewarding process is a computer-implemented process for shipping a reward.

31. The server as set forth in claim 25,
wherein said rewarding process is a computer-implemented process for discounting an Internet connection fee.

32. The server as set forth in one claim 25,
wherein the server is a WWW server.

33. The server a s set forth in claim 32,
wherein the server is a WWW server of a portal site.

34. The server as set forth in claim 32,
wherein the server is a WWW server of a provider.

35. The server as set forth in claim 25,
wherein the object is one of a character string, a picture, or a symbol.

36. The server as set forth in claim 25,
wherein the object is an advertisement.

37. The server as set forth in claim 25, further comprising:
means for totalizing the event log.

38. The server as set forth in claim 25, further comprising:
a record medium for recording the event log.

39. The server as set forth in claim 25, further comprising:
means for transmitting the event log to the user terminal unit.

40. The server as set forth in claim 39, further comprising:
means for encrypting the event log that is transmitted to the user terminal unit.

41. The server as set forth in claims 25, further comprising:
means for transmitting a user information input web page for inputting user information about the user to the user terminal unit;
means for receiving the user information that is input to the user information input web page from the user terminal unit; and
means for correlatively recording the received user information and the identifier of the user.
